(19) United States
(12) Patent Application Publication
(10) Pub. No.: US 2016/0071116 A1
(43) Pub. Date: Mar. 10, 2016

(54) USER PROFILING SYSTEM AND METHOD THEREFOR

(71) Applicant: SITA Information Networking Computing UK Limited, Hayes (GB)

(72) Inventors: Stuart Alan ATKINS, Hayes (GB); Sean WOODBRIDGE, Hayes (GB)

(21) Appl. No.: 14/481,378

(22) Filed: Sep. 9, 2014

(51) Int. Cl. G06Q 30/02; G06Q 50/14; G06Q 10/02

(52) U.S. Cl. CPC G06Q 30/0201; G06Q 10/02; G06Q 50/14

(57) ABSTRACT

A user profiling system and method are described. The system comprises a receiver for receiving event trigger data in response to a user interacting with an environment; a processor configured to: uniquely determine user identifier data associated with the event trigger data; and to associate the event trigger data with a user profile associated with the unique user identifier.

### FIELD OF THE INVENTION

This invention relates in general to a customer or user profiling system. This invention also relates to a system for uniquely distinguishing one customer or user from another customer or user. Furthermore, this invention relates to a system for providing customer or user recommendations based on a determined profile. In addition, this invention relates in general to a system for providing customer or user recommendations which may be used by an airline or other transport services provider. The invention also relates to a database for use by such a system, and to an associated data structure of the database.

### BACKGROUND OF THE INVENTION

Many legacy reservation or inventory systems for use by an airline service provider or Global Distribution System (GDS) use UNYSIS or IBM platforms. These are often programmed using TPF or FORTRAN programming languages.

Furthermore, such systems typically use passenger name records (PNR's) to store a passenger itinerary. With such systems, it is difficult to distinguish between different passengers having the same name entry in the PNR and to determine whether different PNR's relate to the same or a different individual, particularly for domestic itineraries where no passport information is captured.

This is particularly the case when a passenger has not subscribed to a loyalty scheme, because less information is available to distinguish between different PNR's having the same name entry.

Furthermore, Global Distribution Systems for airlines typically provide services to travel agents, rather than to individual users or passengers. Thus, current GDS systems do not distinguish between PNR's having the same name entry. Further more with such systems, once a passenger has taken a flight, the relevant booking information for that flight is purged from the reservations system which means that no PNR history is stored in the GDS.

Furthermore, with legacy systems, airlines are only able to calculate value for passengers who subscribe to a frequent flyer scheme which may categorise passengers as Gold, Platinum, Silver, and Bronze and so on. Such systems require active opt-in by passengers, and as a consequence, only a smaller number of passengers subscribe to frequent flyer schemes.

### SUMMARY OF THE INVENTION

The invention aims to address these problems by providing a system for uniquely distinguishing a customer based on information, such as personal information provided by the customer. The information may comprise one or more of name, address, and other personal information. Embodiments of the invention may use a combination of deterministic processing logic and probabilistic processing logic or algorithms. In some aspects if a passenger provides sufficient information, then the system may determine an exact match to a profile. However, if a passenger does not provide sufficient detail for an exact match, then the system may return a plurality of profiles, and embodiments of the invention may use a probabilistic approach and request further data from a customer to uniquely distinguish a customer from a plurality of different customers.

Embodiments of the invention may associate a customer profile with the customer. The system may also associate events, such as booking, travel and service events with the customer profile. The system may provide customer recommendations based on a unique profile associated with the customer and the events.

Accordingly, embodiments of the invention may distinguish between one passenger, for example John Smith, on one flight from a passenger on a different flight having the same name and determine that these are in fact different individuals. This may be achieved by matching each individual's personal details to their Customer Profile. Accordingly, embodiments of the invention may uniquely recognise a passenger, rather than just a booking, event though the passenger may not subscribe to a frequent flyer scheme.

In this way, embodiments of the invention may capture events associated with a particular passenger and associate a number of different events with the same profile for a particular passenger. The event types may be extensible and configurable so that new event types may be added as event types are defined by updateable content in the database.

Embodiments of the invention may determine a user or customer value from the one or more passenger attributes. Preferably, embodiments of the invention may determine a user value based on their importance to the airline and, their frequent flyer tier level. For customers without frequent flyer membership, embodiments of the invention may determine a user value based on their importance and their flight history and bookings. Further, the value may be determined not only based on future bookings but also based on previous bookings which may have occurred in the past. The history may comprise a plurality of different reservation booking designators, RBD's, each designator associated with a segment of a journey. In some examples, a segment may correspond to a leg of a journey, but legs may be relevant to defining the movement of aircraft between an origin and destination, while segments may be relevant to defining the movement of passengers between what may be in some examples, a different origin and destination. Accordingly, a segment may comprise one or more legs.

Furthermore, embodiments of the invention may determine a link-adjusted value based on relationships between different profiles. Embodiments of the invention may comprise a system which determines a link-adjusted user, customer or passenger value. In one example, a link-adjusted passenger value may be determined based on a nearest neighbour link associated with the user, customer of passenger profile. Preferably, the link-adjusted value is stored in the customers profile with a storage means.

Embodiments of the invention may store one or more determined customer or user values and may store one or more rules in a storage means such as a hard disk, flash memory, ROM, RAM or other storage means which will be known to the skilled person. The calculated values and rules may be decoupled. Accordingly, embodiments of the invention have the advantage that a value calculation algorithm can easily be modified whilst using the same rules. Accordingly, embodiments of the invention may have the advantage that a subscriber airline may easily change the value calculation algorithm to make adjustments to suit their own business needs. Embodiments of the invention may allow airlines to directly see how these changes affect value calculated for a typical range of hypothetical customers. Thus, the system may be configurable by a subscriber airline. This allows for greater flexibility for subscriber airlines that will usually configure selected weights or thresholds for the different types of information that feed into value calculation.

Embodiments of the invention may determine a numeric value associated with a user. The value may have finer granularity than the 5-tier system used in conjunction with frequent flyer schemes. In one specific example, passenger value may be characterised by a number in the range of 1 to 100 inclusive. However, embodiments of the invention may determine a tiered customer value such as a, b, c, or d and so on.

Embodiments of the invention may calculate value for all passengers irrespective of whether the passenger has subscribed to a frequent flyer scheme.

Further, embodiments of the invention may provide value-aware recommendations for both passengers who subscribe to frequent flyer schemes as well as those who do not subscribe to a frequent flyer scheme by using flight and booking history instead of frequent flyer tier information to calculate customer value.

The recommendations may be dynamically generated at a mid-tier level by taking mid-tier data into account when determining a user value. Embodiments of the invention may use the determined value to match or associate a recommendation to a user or customers.

Preferably, embodiments of the invention associate one or more events, which occur to, for example, a particular non-uniquely named passenger and associate one or more of those events with a unique identifier associated with a passenger name.

Embodiments of the invention may comprise storage means for storing one or more events as well as storage means for storing one or more bookings. The events may be associated with one or more of bookings. Preferably, bookings may be stored for one year. In this way, embodiments of the invention may have access to much more history than is currently available to CRS using a PNR based system. Subscriber Airlines may also elect to store bookings for longer than a year.

A system embodying the invention may determine that one or more events may have occurred an airport, or even prior to arriving at the airport, for example during the booking process.

The events may be recorded in a profile uniquely associated with one passenger. For example, a passenger may call customer service helpline, and this event may be store in profile would never be stored in a PNR based system. Customer interests such as hobbies and so on may also be taken in to account match recommendations to a particular and preferably unique passenger profile.

Embodiments of the invention may match recommendations to a profile based on a customers events, value, birth date and interests.

Embodiments of the invention may recognise or distinguish between different customers based on information provided by a customer. This is in contrast with known PNR based systems, which only recognise bookings.

Embodiments of the invention may uniquely recognise a customer and associate one or more events with that particular customer. Preferably, the system determines a value associated with that customer.

The association of events with a particular customer and the calculation of a value associated with the customer may enable recommendations to be made for a particular customer. Optionally, interests recorded by customers may further enable recommendations to be made for a particular customer.

Embodiments of the invention may comprise an algorithm which takes customer interaction with a subscriber airline into account and whether a disservice has occurred, or/and whether it has been resolved, when providing recommendations. For example, if the system determines that the disservice has not been resolved, then assigned customer value is increased by a predetermined value.

Embodiments of the invention may provide a service, which obtains a customer, profile value and determines a modified customer profile value. Preferably, the system generates recommendations based on the rules.

Embodiments of the invention may send one or more customer values to external services for use in other value-aware algorithms such as preferential seating re-accommodation. This may be performed using XML or other structured message types to exchange information.

At a profile level, embodiments of the invention may use a profile link entity to link one profile to another, different profile. Embodiments of the invention adjust the value of the profile based on a link distance of one. For example, a profile may be linked to a related profile.

Embodiments of the invention generate one or more recommendations based on a determined adjusted user value and a determined event associated with a user. The recommendations may be generated in real time in response to a user interacting with a touch point such as check-in, security, boarding, or departure gate. The user may interact by scanning a boarding pass or passport on a scanning device.

Events may be triggered by a number of different processes with which the customer or user interacts with a product or service provider or airport infrastructure provider. The events may comprise an indication that a user has made or changed a booking, or has completed a journey or flight.

When an event occurs, embodiments of the invention may update a profile activity associated with a unique customer with the event.

Events may trigger the system to automatically generate a recommendation. A customer service executive may use a system embodying the invention to retrieve a profile associated with a customer and display one or more events which are associated with the profile. Disservice events may remain ‘unfulfilled’ in the profile until a recommendation has been offered to the customer to recover from the disservice. In this way, an airline can ensure that recovery actions are always taken for customers who have experienced a disservice.

### BRIEF DESCRIPTION OF THE DRAWINGS

An embodiment of the invention will now be described, by way of example only, and with reference to the accompanying drawings, in which:

FIG. 1 is a schematic diagram of the main functional components embodying the invention;

FIG. 2 is a schematic diagram of an embodiment of the invention showing a logical level architecture of a customer profile system which has been simplified for clarity;

FIG. 3 is a diagram showing some example rules used by embodiments of the invention;

FIG. 4 shows graphical user interface for use by a user such as a customer service executive which allows rules to be established for recommendations based on events according to airline policy on customer service;

FIG. 5 shows a further graphical user interface for use by a user such as a customer service executive which allows recommendation rules to be viewed, edited, and/or deleted;

FIG. 6 shows a further graphical user interface for use by a user such as an airline employee which allows a recommendation to be viewed on a reservation desktop;

FIG. 7 is a flow diagram showing the processing steps performed by an embodiment of the invention as well as how an embodiment of the invention interacts with other systems;

FIG. 8 shows a further graphical user interface for use by a user such as an airline employee showing a profile activity screen; and

FIG. 9 is a flow diagram showing the main steps performed by an embodiment of the invention.

The following description is of a system for use in the aviation industry, but this is exemplary and other applications of the invention will also be discussed. For example, the system may be used in any environment where a product or service is provided to a user or customer, or indeed in any environment where user profiling is performed. Thus, embodiments of the invention find application in the travel industry in general (for example rail, air, coach and the like), but also in the ticketing industry, such as ticketing for theatre, cinema, and the like.

The system may be embodied in a hosted system (for example hosted by an airline) which may use API communications protocols to communicate with external systems such as reservation systems.

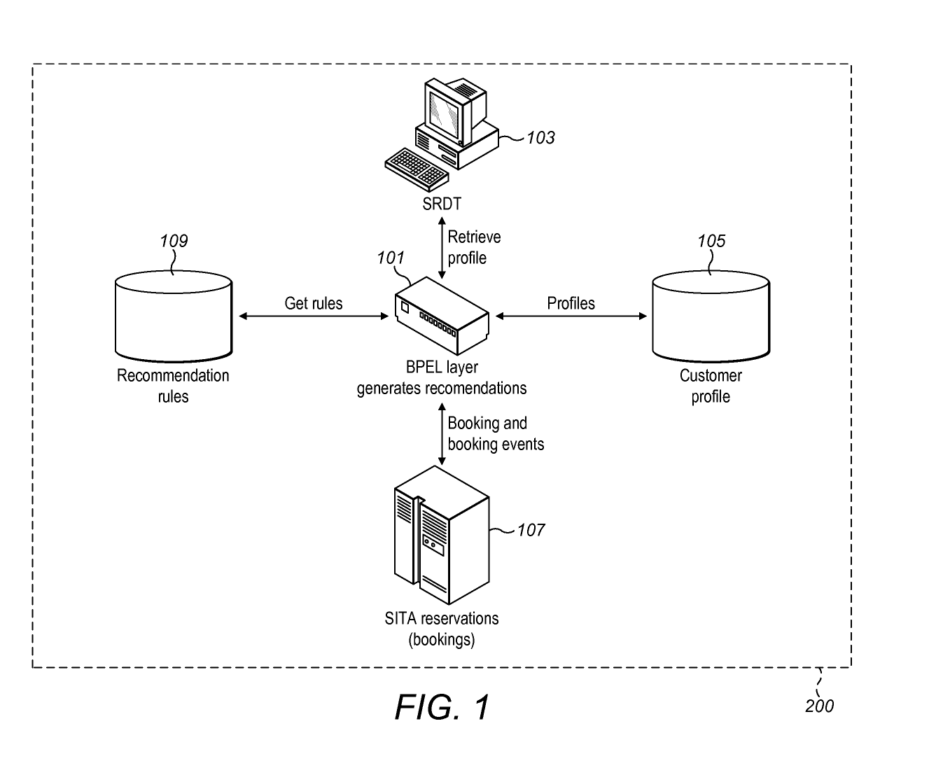

FIG. 1 is a schematic diagram showing the service architecture of a system embodying the invention. This service may be provided as a part of a Horizon Customer Profile product option within a SITA Reservations Desktop GUI.

In this embodiment, recommendations are built on a SOA suite Oracle BPEL platform. However, other platforms known to the skilled person may be used. For example, other platforms or programming languages may be used such as C++, JAVA, and .xml may be used as well as other programming languages which will be known to the skilled person.

For example, embodiments of the invention may use one of these programming languages to provide a web-based service.

The system 200 may comprise one or more of the following components: a server 103 such as a SRDT computer server which is communicatively coupled, via wired or wireless transmission means which will be know to the skilled person, to an Oracle BPEL process manager residing on computer or server 101. In the schematic diagram of FIG. 1, two separate computer servers 101, 103 are shown, but in principle, a single server may be provided which both generates one or more recommendations and retrieves one or more profiles.

In the schematic diagram of FIG. 1, a customer profile and recommendation rules are schematically illustrated as being stored on separate storage means, but the customer profile 105 and rules 109 may be stored on a single storage means. In any case, the stored rules 109 and customer profile 105 are communicatively coupled to the BPEL layer server 101. Accordingly, the BPEL layer server 101 may retrieve one or more rules from the storage means 109. Further, the server 101 may also retrieve one or more customer profiles from the storage means 105. Finally, the system 200 may comprise a reservations or bookings system or server such as a SITA reservations or bookings system or server 107. The reservations server 107 controls the availability of seats on a flight or leg/segment of a journey, and will not be described in further detail as such reservations systems are known to the skilled person.

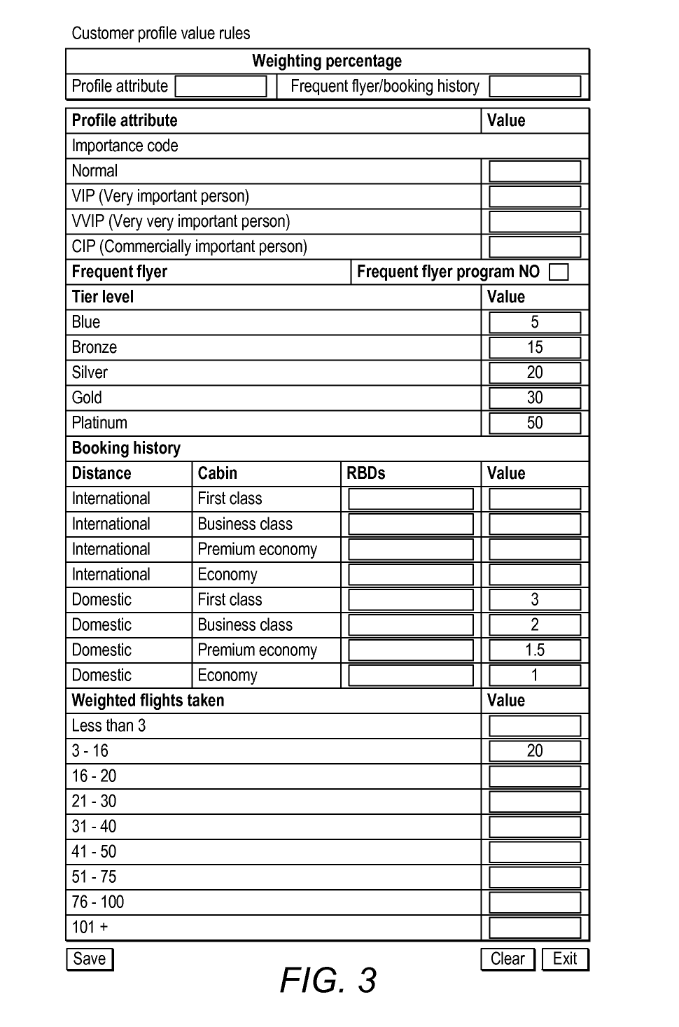

When a profile is retrieved, the system may use mid-tier architecture to obtain the value of the customer based on the profile and generates the recommendations by applying a rule that may be configured by an airline, to the profile that has been retrieved. Determination of the customer value is described in detail below with particular reference to FIG. 3 of the drawings.

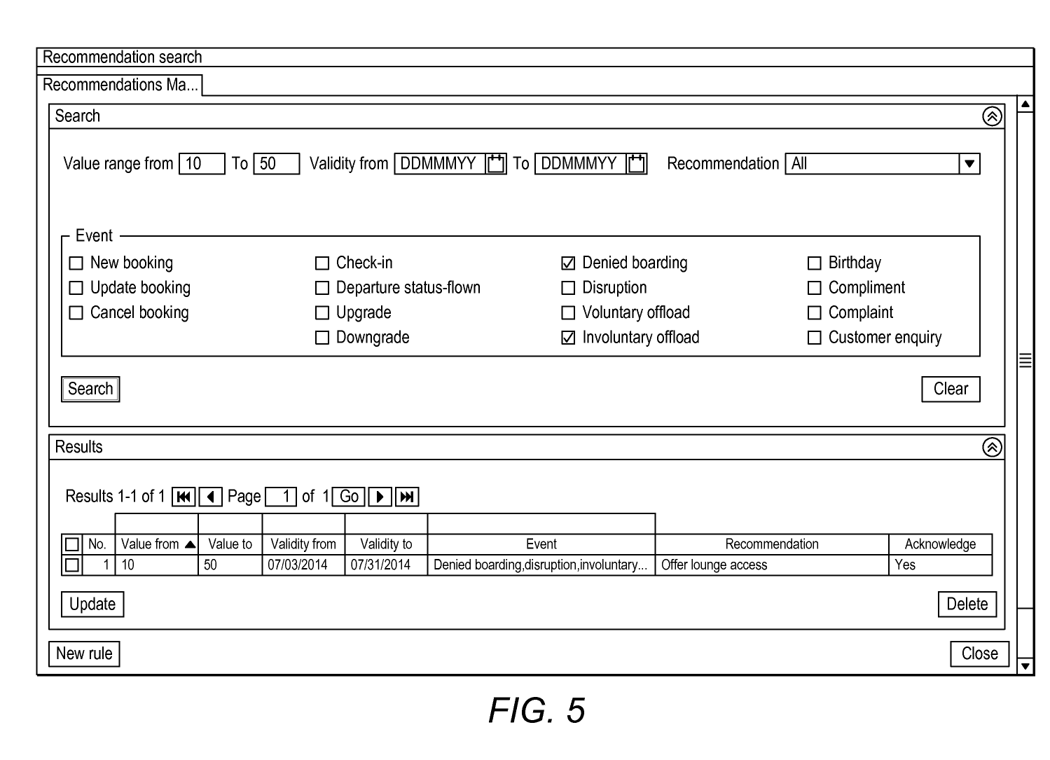

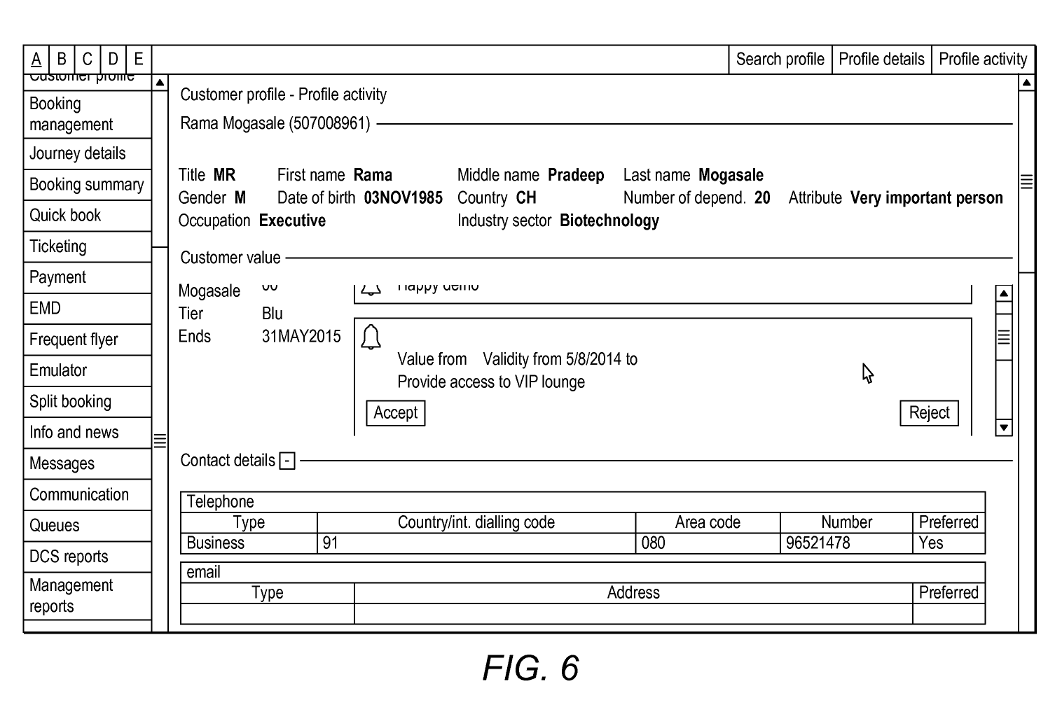

The rules and recommendations will be described in further detail with reference to FIGS. 5 and 6 below. However, recommendations may be thought of as alerts that are displayed to an agent that helps the agent understand the airline's customer service response to a specific customer given detail of that customer including their value and any events that have been recorded in the customer's profile. Recommendations may be dynamically generated based on the interaction that occurs between the agent and the customer's profile. Recommendations may comprise textual alerts and may be recorded in the profile, described in further detail below.

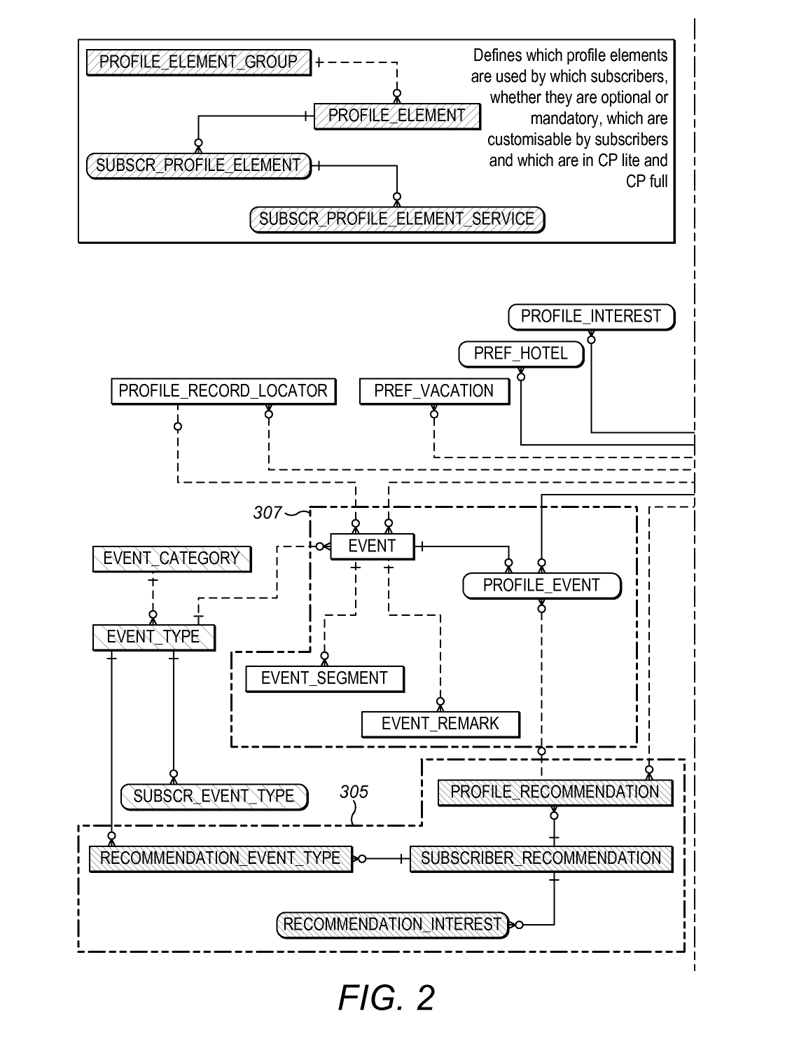

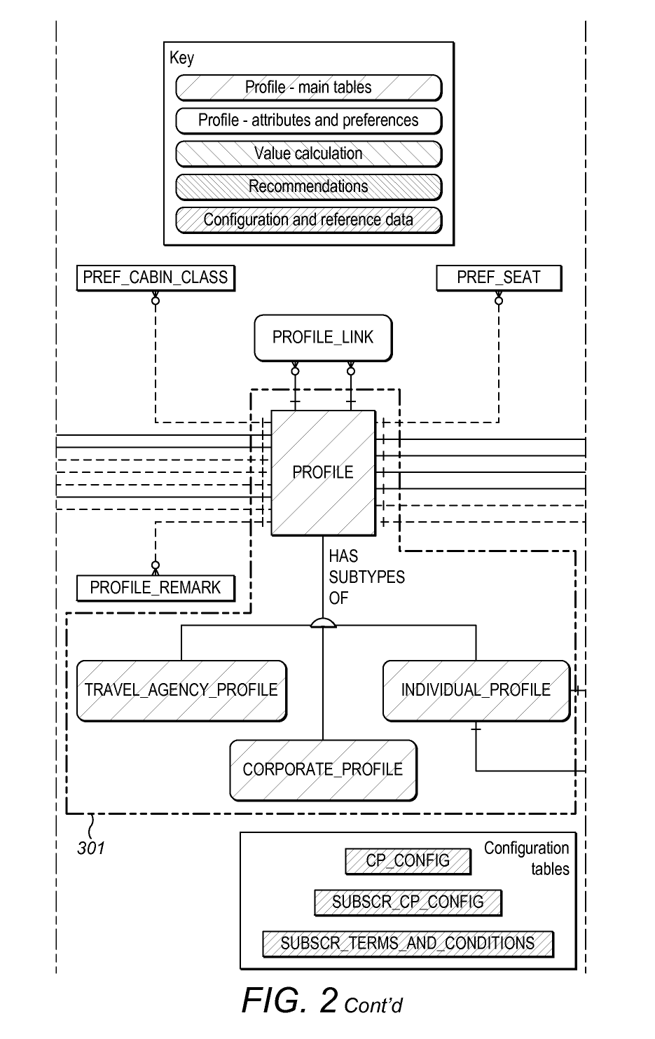

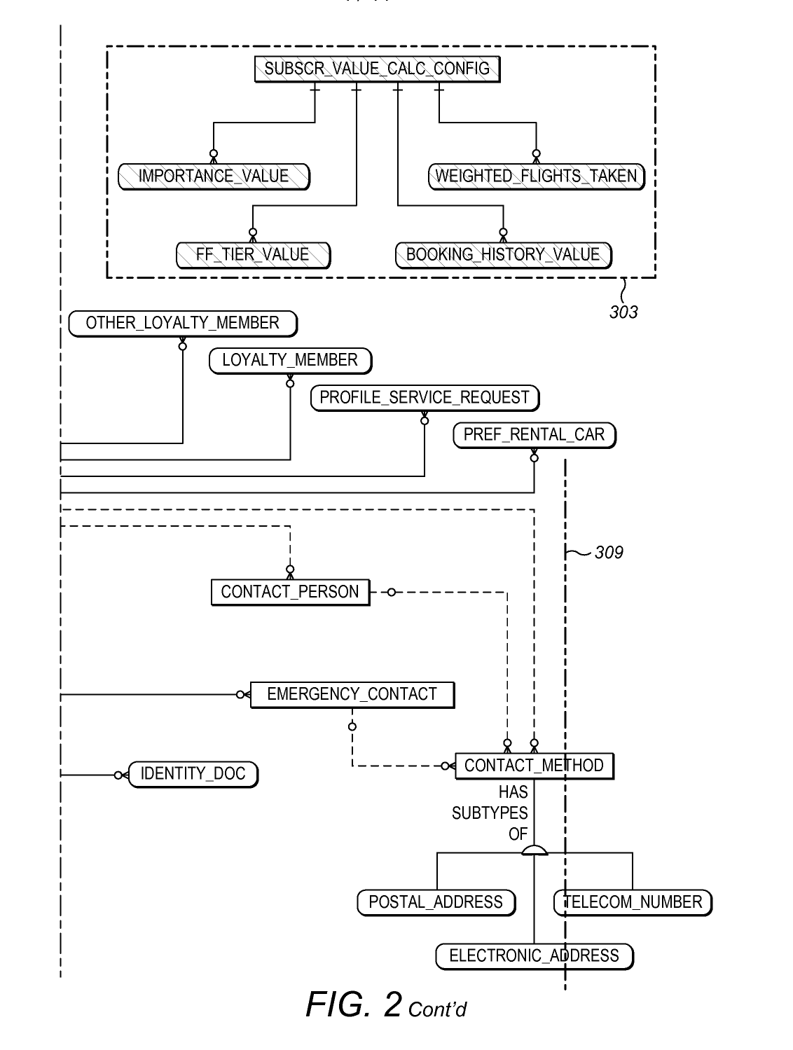

FIG. 2 is a schematic diagram of an embodiment of the invention showing a logical level architecture of a customer profile system embodying the invention which has been simplified for clarity. This may be referred to as a drillable data dictionary comprising various different entities, attributes as well as relationships or associations between the different entities and different attributes.

An entity may also be referred to as a table, while an attribute may be referred to as columns or fields. Entities are uniquely identified by Primary Keys while relationships between different entities or attributes may be determined by one or more Foreign keys i.e. a key in an entity that is not the identifying Primary Key of the entity, but is rather a reference to the identifying Primary Key of a related Foreign entity.

One example of an entity is a booking history value entity that a subscriber (such as an airline) assigns by Distance (International/Domestic), Cabin Class and Reservations/Booking Designator (RBD) list, and so on. The booking history value entity may comprise one or more attributes or characteristics.

For example, the attributes may comprise a profile attribute, a frequent flyer attribute or a booking history attribute, as described in further detail with reference to FIG. 3 below.

Profile attributes are shown within the dashed line 301 in FIG. 2, while recommendation attributes are shown within the dashed line 305, and event attributes are shown within dashed line 307 in FIG. 2. FIG. 2 also shows attributes within the dashed line 303 which may be used in the determination of a subscriber value calculation. The value determination may be performed by computer hardware or software which may be separate from the database.

The profile main tables are shown enclosed within the dashed line 301. A profile table may comprise, an individual profile subtype, INDIVIDUAL_PROFILE. The INDIVIDUAL_PROFILE entity is a subtype of the PROFILE entity and may store details of individuals.

Each of these sub entities may comprise an IMPORTANCE_CODE attribute. This attribute may comprise code representing the importance of the Customer for use in the Value Calculation algorithm. Values include VIP=Very Important, VVIP=Extremely Important, CIP=Commercially Important.

Each of these sub entities may further comprise a CUSTOMER_VALUE attribute. This attribute may comprise a value which has been assigned to the Individual by or on behalf of the subscriber. It may represent the value of the Individual to the Subscriber.

Further each of these sub-entities may further comprise a LINK_ADJUSTED_CUSTOMER_VALUE. This value may be determined by adjusting the CUSTOMER_VALUE to take into account the value of any linked Profiles.

Embodiments of the invention may copy a profile identifier into a profile link. In this way, embodiments of the invention may only consider links where the profile identifier is present in profile link. A link usually comprises two different profile identifiers and individual customer profiles may be additionally be linked to corporate or travel agency profiles.

Shown within a dashed line 303 in FIG. 2 is a schematic diagram showing the different parameters or attributes which embodiments of the invention may take into account when performing a subscriber value calculation. In this example, the determination of the subscriber value may take one or more of an importance value, frequent flyer tier value, booking history value and weighted flights taken parameters into account when determining a subscriber value.

The SUBSCR_VALUE_CALC_CONFIG entity may define weightings within a Value Calculation Rule Configuration for a Subscriber. Each Subscriber may have a different set of rules for each Profile Type. As part of the rule the contribution of each attribute to the overall value calculation may be specified. This will be described in further detail below with particular reference to FIG. 3 of the drawings. Attributes may be in the range from 0 to 100 percent contribution and the total of all attributes may add up to 100 percent i.e. IMPORTANCE_WEIGHTING_PCT+FF_BOOKING_HIST_WEIGHTING_PCT may equal 100 in some examples.

The IMPORTANCE_VALUE attribute may comprise a value defined for the IMPORTANCE_CODE by the Subscriber for each Profile Type, as a contribution to the calculation of Profile Value.

The FF_TIER_VALUE logical entity may comprise a value defined for the FF_Tier by the Subscriber for each Profile Type, as a contribution to the calculation of Profile Value.

The BOOKING_HISTORY_VALUE logical entity may comprise values that a Subscriber assigns by Distance (International/Domestic), Cabin Class and RBD list, as a contribution to the Value Calculation algorithm, subject to the weighting defined in SUBSCR_VALUE_CALC_CONFIG.FF_BOOKING_HISTORY_WEIGHTING_PCT. These values may be multiplied by the values in WEGHTED_FLIGHTS_TAKEN to determine the contribution of a Customers booking history to their value. In some examples, the information in this table and in WEIGHTED_FLIGHTS_TAKEN is only used as an alternative to FF Tier when the Subscriber has no Frequent Flyer Scheme or when the Customer is not a member of the Subscribers FF scheme.

The WEIGHTED_FLIGHTS_TAKEN logical entity may comprise values that a Subscriber can define any number of ranges, each of which is a range of total flights flown, and may define values multipliers for each of those ranges to be used in the Customer Value Calculation algorithm. Only the upper bound of the range needs to be stored in order for the service to derive the actual ranges. The first range starts at 0, all subsequent ranges may be contiguous and the last range has no upper bound. For example if a Customer has flown 20 flights and there is a range defined as 16 to 21 then the Value associated with that range is incorporated into the Value Calculation algorithm to be multiplied by the Distance/Cabin Class/RBD values in BOOKING_HISTORY_VALUE and then subjected to the FF_BOOKING_HIST_WEIGHTING+PCT stored in the parent Rule in SUBSCR_VALUE_CALC_CONFIG. In some examples, the information in this table and in BOOKING_HISTORY_VALUE is only used as an alternative to FF Tier when the Subscriber has no Frequent Flyer Scheme or when the Customer is not a member of the Subscribers FF scheme.

Shown within a dashed line 305 is a profile recommendation table, entity or data, PROFILE_RECOMMENDATION. This may comprise a list of Recommendations that have been acted upon for the Profile i.e. an Agent has noticed a recommendation relevant to a Profile and has followed or actioned the Recommendation. The Agent who actioned the Recommendation is recorded along with the date and time of actioning and if Customer acceptance of the Recommendation is needed (as determined by the ACCEPTANCE_REQUIRED_IND in SUBSCRIBER_RECOMMENDATION) then whether or not the Recommendation was accepted should also be recorded by setting the ACCEPTED_IND.

Also shown within dashed line 305 of FIG. 2 is a SUBSCRIBER_RECOMMENDATION entity. This may comprise data defining Recommendations entered by a Subscriber that are available to be matched to the Subscribers Profiles and displayed to an Agent who may elect to offer the Recommendation to a Customer. Recommendations either require acknowledgement (acceptance or rejection) or not. In some examples, recommendations that do not require acknowledgement are not stored in the Profile. Those that do are only stored in the Profile (in PROFILE_RECOMMENDATION) if the Recommendation was either Accepted or Rejected. If it was neither of those then we can infer that the Recommendation was ignored (whether by the Agent or by the Customer is irrelevant as the consequence is the same) in which case it is not stored in the Profile and it is available to be made again. Some Recommendations may be for particular Event Types and are matched to Profile containing instances of those Event Types (in PROFILE_EVENT). If such a Recommendation is stored in the Profile then it is also linked to the Event or Events that caused it to be matched to the Profile, thereby fulfilling the Event and ensuring that no further Recommendations for that PROFILE_EVENT are matched to the Profile.

Also shown within dashed line 305 is a RECOMMENDATION_EVENT_TYPE entity. This may comprise data which enables Subscribers to associate Recommendations with Event Types for the purpose of matching Recommendations to Profiles, for example, to offer service recovery for an adverse Event Type such as an Offload, or flight disruption event such as delay, cancellation, or re-route event.

Finally, also shown within dashed line 305 of FIG. 2 is RECOMMENDATION_INTEREST logical entity. This may comprise data which enables Subscribers to associate Recommendations with Interests for the purpose of matching Recommendations to Profiles having the same or similar Interests.

Logical entities associated with events are also shown within figure the dashed line 307 of FIG. 2. Shown within dashed line 307 is an event table, entity or data. This entity records the details of the occurrence of events, which involves particular Profiles. By definition, an Event always involves at least one Profile. An Event may also involve more than one Profile; for example, a Booking Event will involve all of those Profiles which are travelling on that Booking. An Event has an Origin which must be one, and only one, of an Agent, a System or a Profile. In some examples, this entity is not updatable.

As can be seen from FIG. 2, events are associated with a particular profile, and as previously described, each profile may be associated with a value. Further, each profile may also be associated with a LINK_ADJUSTED value.

In one example, a particular customer profile identifier, for example the identifier of a profile associated with a first customer, such as the daughter of an executive of a company, may be included in a profile link, wherein the link comprises two different profile identifiers, one associated with the first customer and the other associated with a second customer for example an executive of a company.

For example, the processor may determine a link-adjusted customer value based on data associated with the profile link. In some specific examples, a link-adjusted customer value may be determined by determining the customer value associated with a profile identifier, for a second customer, stored in a profile link. In one specific example, the processor may increase a customer value by a predetermined value if the processor determines that the customer value associated with the customer profile for the second customer is greater than the customer value associated with the second customer profile.

Next nearest neighbour links may be taken into account when determining the link adjusted value. For example, a first customer profile associated with a customer may comprise a profile link. The profile link may comprise first and second profile identifiers associated with the first customer and a second customer respectively.

A second customer profile may be associated with the second customer. The second customer profile may have a further profile link. The further profile link may comprise two different profile identifiers, one associated with the second customer and a third profile identifier associated with a further, third customer.

In this example, the processor may determine a link-adjusted customer value based on data associated with the profile link and data associated with the further profile link.

In one specific example, a link-adjusted customer value may be determined by determining the customer value associated with a profile identifier stored in the profile link and the customer value associated with a profile identifier stored in the further profile link.

In one specific example, a link-adjusted customer value may be determined by determining the customer value associated with a profile identifier, for a second customer, stored in a profile link, and the customer value associated with a further profile identifier, for a third customer stored in a further profile link where the third profile link is associated with the first customer and a third customer, and not the second customer.

The processor may increase a customer value by a predetermined value if the processor determines that the customer value associated with the customer profile for the third customer is greater than the customer value associated with the first customer profile, irrespective of whether the processor has increased the customer value for the first customer, as previously described with reference to nearest neighbour links.

In addition, even if the processor has previously increased the customer value for a first customer by a predetermined amount, the processor may make a determination of whether the customer value associated with the customer profile for the third customer is greater than the customer value associated with the second customer profile. The processor may then increase or further increase the customer value for the first customer by a predetermined amount. Any of these values may be stored in storage means.

In this way, recommendations may be provided to a subscriber airline based on an event or/value or both. FIG. 2 also shows a PROFILE_INTEREST logical attribute. This attribute may comprise data, for a particular Individual Profile, which records details of the Customers Interests. Typical examples include ‘Football’ and ‘Opera’. Note that this entity is not updatable.

FIG. 3 is a diagram showing some example rules used by embodiments of the invention and how different values may be associated with different profile attributes. In FIG. 3, some specific example values are shown, but of course, these are only examples. For example, a Blue level frequent flyer tier level is associated with value of 5, a Bronze tier frequent flyer level is associated with a value of 15, a Silver tier frequent flyer level is associated with a value of 20, a Gold tier frequent flyer level is associated with a value of 30, and a Platinum tier frequent flyer level is associated with a value of 50. Further, as shown in FIG. 3, a domestic first class booking history RBD is associated with a value of 3, a domestic business class booking history is associated with a value of 2, a domestic premium economy booking history RBD is associated with a value of 1.5 and a domesic economy RBD is associated with a value of 1. The specific RBDs are not shown in FIG. 3, but these usually comprise one or more alpha-numeric or alphabetic characters such as F, J, Y, S, L, X or Z which may be associated with different ticket types sold by an airline.

In one example, a Horizon Customer Profile system embodying the invention may either calculate a value itself with an algorithm or it may store a value calculated by another source such as an external CRM system. In the example shown in FIG. 3, for a specific customer, a value of 20 is determined by summing the booking history values for that customer or passenger of 3, 2, 1.5 and 1 which equals 7.5, which falls within the second banding of weighted flights taken of between 3 to 16. A mapping may be provided from the determined sum of booking history values of 7.5 to a value of 20, such as a customer value.

The algorithm for customer value calculation within Horizon Customer Profile may be performed with the following options but configured and weighted by an airline.

The value may be a number between 1-100 with 100 being the highest value. The items that are included in this value calculation are:

1. Frequent Flier tier level;

2. No. and value of bookings (by RBD) in a 12 month period; and

3. Profile attributes (e.g. VIP, Commercially important)

Each area has a percentage of the total and a value associated with it. The value may be determined by adding of all the factors provides a value to be used in processes throughout the Passenger Service System (PSS).

In the Customer Value Rules there may be 5 tables which may be used to calculate the Customer's Value to the airline or subscriber. The tables are described in further detail below:
Weighting Criteria—This table splits the customer value between the customer's attribute, as determined by the subscriber, and the customer's frequent flyer status or booking history, if the customer does not have a frequent flyer status. These 2 fields may not be greater than 100%.
CP Attribute—The subscribing airline may assign a designation to a customer such VIP. The subscriber assigns each designation a value indicating its importance.
Frequent Flyer (FF) Tier—If a subscriber has a frequent flyer program it will have levels which provide specific benefits to the customer. The subscriber will assign a value to each level. The actual tiers will be pulled from the subscriber's FF database. The levels shown here are for explanation purposes only.
Distance/Cabin—Booking history has 2 tables. The first is the Distance/Cabin. The distance portion is either domestic or international. There are 4 cabins which are associated with each distance. The cabin is determined by the RBD shown in the Value Rules Configuration. Each distance/cabin combination, there are 8, has multiplication factor (multiplier column) assigned by the subscriber which indicates the distance/cabin value to the subscriber. For instance the least expensive domestic economy may be valued at 1 and the most expensive, international first class may have a value of 4. Intermediate value fares may be associated with any value between 1 and 4.
Weighted Flights Taken—This table gives the booking value of the flights as determined by totalling the distance/cabin flight segments.

In the following examples, one uses frequent flyer data and one using booking history data.

The passengers in these examples are made up on 50% Customer Profile Attribute and 50% FF Tier Level/Booking History

### EXAMPLE 1

### Passenger 1: Normal and Blue

1. Normal has an Attribute Value of 10.
2. The Weighted Value of the CP Attribute is 50%. Multiply 10 by 50%=5.
3. Blue Tier has a value of 10.
4. Weighted Value of the FF Tier is 50%. Multiply 10 by 50%=5.
5. Weighted CP Attribute+Weighted FF Tier=Customer Value (Table 1) 5+5=10
6. 10 is the Customer Value which would be entered into the Customer Profile.

### EXAMPLE 2

### Passenger 6: Normal, 1 Int'l Economy, 4 Domestic Economies

1. Normal has an Attribute Value of 10.
2. The Weighted Value of the CP Attribute is 50%. Multiply 10 by 50%=5.
3. Intl economy has a value weighting of 1.5. Multiply the number of flights (1) by the multiplier (1.5)=1.5
4. Domestic economy has a value weighting of 1. Multiply the number of Domestic economy (4) by the multiplier (1)=4.
5. Total the weighted flights to get the total weighted value of the distance/cabin (Table 4) 1.5+4=5.5.
6. The answer in Step 5 is greater than 3 but less than 15. The Booking Value is 10.
7. Weighted Value for Booking History is 50%. Multiply 10 by 50%=5.
8. CP Attribute+Booking History=Customer Value. 5+5=10
9. 10 is the Customer Value which would be entered into the Customer Profile.

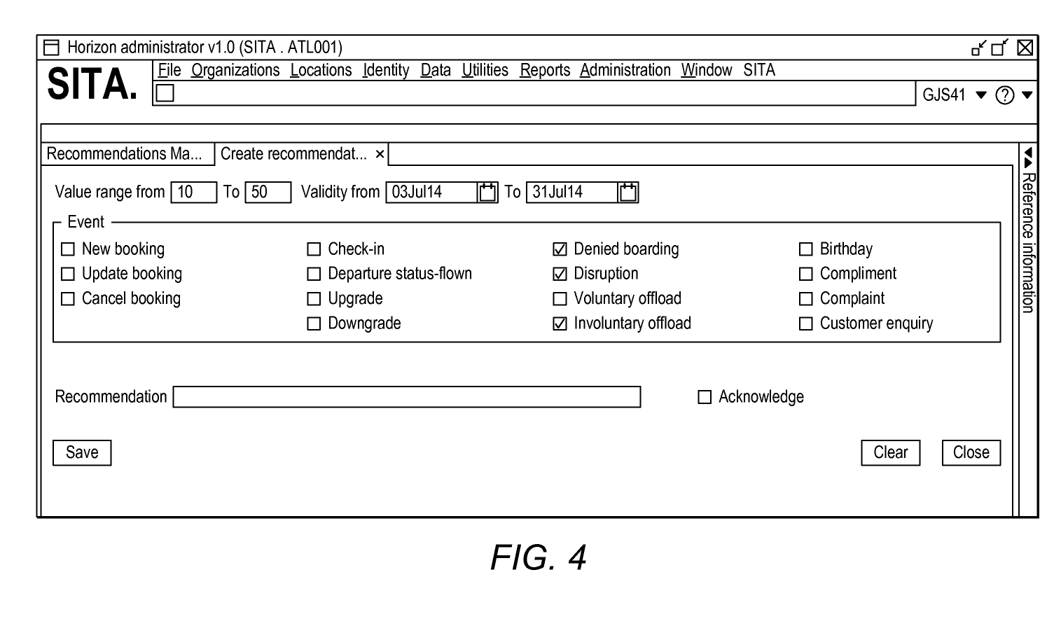

FIG. 4 shows a GUI embodying the invention which may allow a subscriber airline to establish rules for recommendations based on events. In one example, the events may comprise booking events or service/disservice events that may be recorded in a profile, together with the value or value range for a customer. Other events may comprise a new booking event, and update booking event, a cancel booking event, a check-in event, a departure status—flown event, a paid for a booking event an upgrade event, a downgrade event, a denied boarding event, a disruption event, a voluntary offload event, an involuntary offload event, a birthday event, a compliment event, a complaint event and a customer enquire event, but other events will be known to the skilled person.

In the specific example shown in FIG. 4, a user is in the process of creating a recommendation associated with a user in the value range from 10 to 50, which is also associated with a validity date range from 3 Jul. 2014 to 31 Jul. 2014. Further, in the example shown in FIG. 5, only some of the check boxes associated with one or more events have been ticked. This may mean that the particular recommendation is only associated with certain events such as denied boarding or disruption or involuntary offload event, and not the other events shown adjacent the tick boxes shown in FIG. 4. As previously described, rules may be established for recommendations based on events according to airline policy on customer service.

Once a recommendation has been entered in the text box adjacent “recommendation”, for example “Upgrade to business class” or “Complementary ticket”. Other recommendations may comprise text which may prompt a customer service executive to wish the customer a happy birthday, apologise for offloading them last time on a previous flight, offer free 1st class lounge access, offer cheap ticket to a sporting or cultural event in their place of destination, offer free upgrade to a high-value customer and so on.

The user may then save the recommendation rule by clicking the “Save” button shown in FIG. 4. The airline may configure the text that is displayed to the user if the rule criteria are true. This may save the rule in a database, such as that previously described referring particularly to FIG. 2 of the drawings. In the example of FIG. 4, the recommendation rule can be flagged to indicate that acknowledgement is required. This may require the agent to ask the customer if they want to accept the recommendation or not.

In this way, a feedback loop between recommendations proposed to a customer by an airline user or subscriber may be made by storing data associated with a recommendation, which is indicative as to whether one or more recommendations have been accepted by a user.

In this way, an airline subscriber can manage recommendations based on whether a customer has accepted one or more recommendations, and FIG. 5 shows a GUI embodying the invention which allows recommendation rules to be viewed, edited, deleted and searched.

In this example, a rule is associated with a denied boarding event and involuntary offload event. The rule is also associated with a customer value range of 10 to 50, which may be determined as previously described. Furthermore, in this example the rule is also associated with a particular validity period from 3 Jul. 2014 to 31 Jul. 2014. Furthermore, in this example, the recommendation is “Offer lounge access” and an acknowledge field is also associated with the recommendation. This may mean that if a customer wishes to accept the recommendation, that an acknowledgement is sent from the server running the GUI and that the acknowledgement may indicate that the recommendation has been accepted.

The acknowledgement may be stored as an attribute and maybe associated with one or more entities by way of the relationships previously described with reference to FIG. 2, particularly referring to the elements enclosed with dashed lines.

FIG. 6 shows a GUI for use by a subscriber such as an airline employee and how recommendations may be viewed on a reservation desktop. For example, an airline may view these recommendations when the profile is retrieved during an interaction with the customer.

In the example shown in FIG. 6, data associated with a particular customer profile is displayed, for example one or more of title, first name, middle name, last name, gender, data of birth, country, number of dependencies, attribute such as a customer value associated with a customer profile, occupation such as executive, and industry sector.

If the recommendation requires acknowledgement—the agent selects to accept/reject the recommendation. If the customer rejects the recommendation, then a user selects the reject button in the GUI, and this may be recorded in the activity profile. The recommendation is then not shown again to the user.

Recommendations may be recorded in the profile activity and this can show what recommendations are being accepted and what are being rejected. In this way, an airline can change rules to provide better control of their service situations.

In some examples, recommendations may be linked to merchandising to utilise recommendations to drive selling directly to customers based on profile attributes, events and value to differentiate—e.g. a higher value customer can buy an ancillary service but with a higher discount.

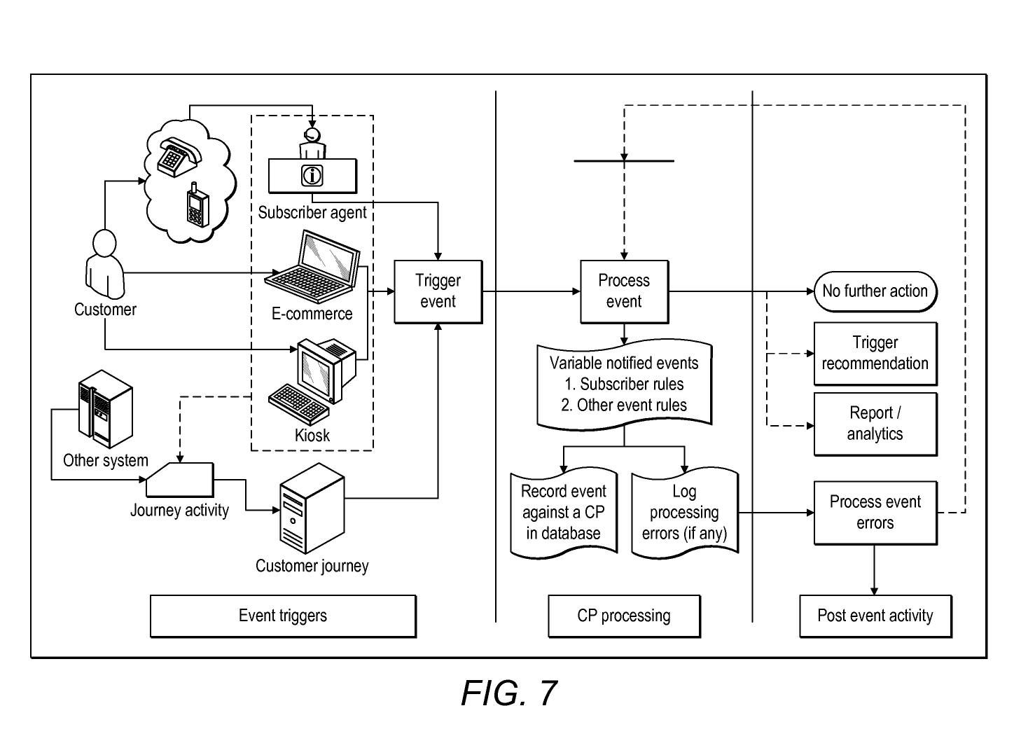

FIG. 7 is a flow diagram showing the processing steps performed by an embodiment of the invention as well as how an embodiment of the invention interacts with other systems.

For example, as shown in FIG. 7, a customer may trigger an event via an interaction with a subscriber agent using a system embodying the invention, for example by making or changing a booking. Furthermore, a customer may also trigger an event by making or changing a booking via a computer, laptop computer or other portable computing device. A customer may also trigger an event based on an interaction with a kiosk at an airport, such as Kiosk for printing a boarding pass.

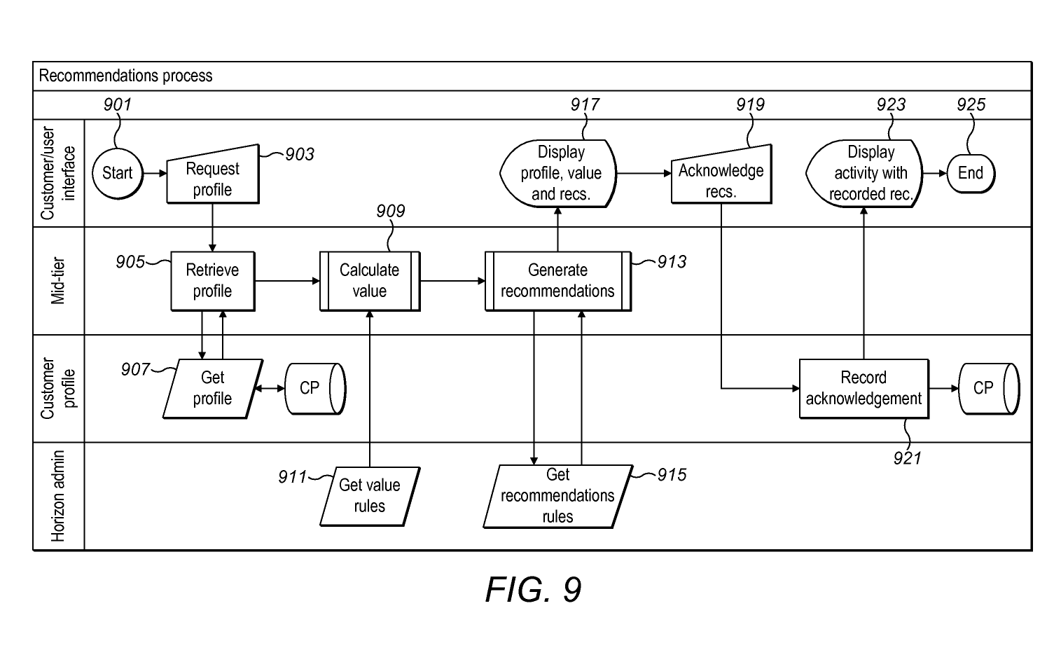

In this embodiment, a trigger event is received by a computer server or system embodying the invention. The event may be processed as previously described to produce an event recommendation, or according to the flow diagram of FIG. 9, or to produce some other post event activity as shown in FIG. 7. For example, the post event activity may comprise no further action or the trigger event may be processed by the system to trigger another event.

Event Errors

Events may be notified from various sources to the Customer Profile system where they are processed and recorded against related customer profiles. Some of these events may be rejected by the system based on business rules or system failures. The rejected events may be logged in the Event Error Log. Usually, rejected events are manually processed.

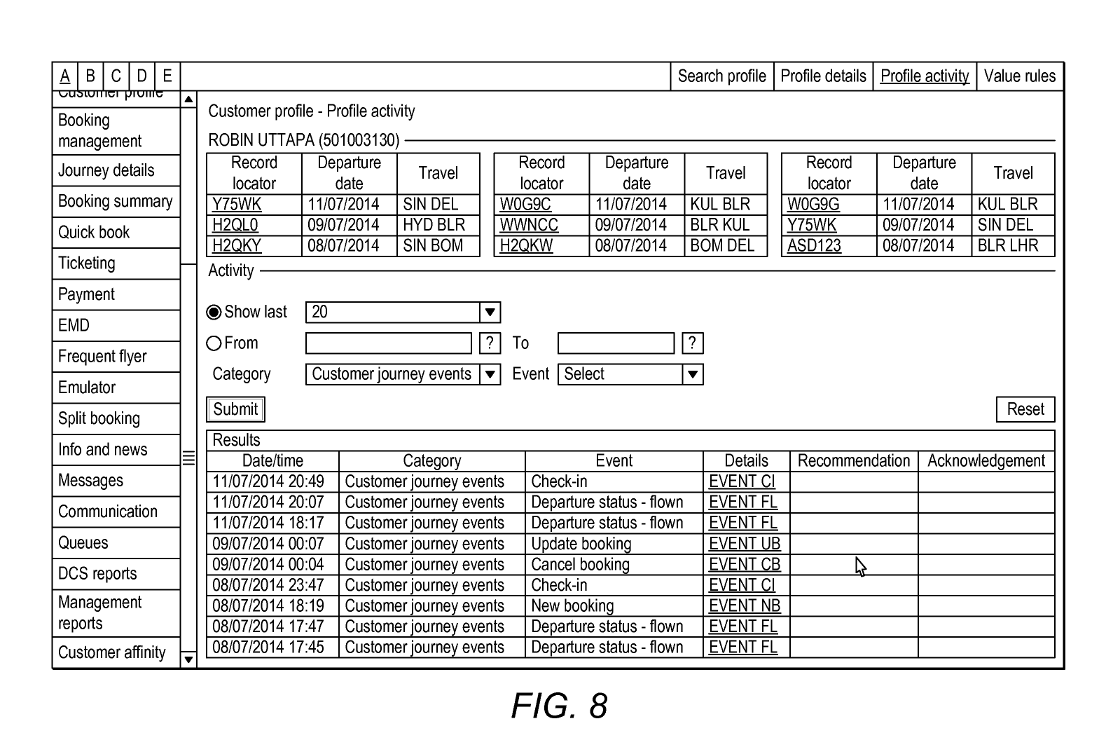

FIG. 8 shows a further graphical user interface for use by a user such as an airline employee showing a profile activity screen. This shows current bookings and recorded events. As previously described, recommendations may be recorded in a profile activity and the profile activity screen may show which recommendations are being accepted and what are being declined. This may allow an airline subscriber to adapt rules so that recommendations are more likely to be accepted by a user or customer such as a passenger in this way, a subscriber may have better control of their service situations.

In the specific example of FIG. 8, the profile activity screen shows data associated with a particular named user identified by name such as first name or surname. The user may have an associated customer number, which in this example is a numeric value, such as 501003130.

In this example, a plurality of different records are associated with this user. Each record may be identified by a record locator identifier which may comprise an alpha-numeric sequence of characters. Each record locator identifier may be associated with a departure date identifier and preferably a travel identifier. The departure date may be in the form of DAY/MONTH/YEAR. The travel identifier may identify a journey between two airports such as Bengaluru (BLR) to London Heathrow (LHR). The journey may be a non-stop flight or may comprise one or more stops between the passenger's origin and destination. Thus, in the specific example of FIG. 8 each record may be associated with a leg or segment of travel.

In the Profile activity screen shown in FIG. 8, no time or date filters have been applied to the text boxes adjacent “From” or “To”. However, by selecting a “Customer Journey Event” filter from the drop down box shown in FIG. 8, only Customer Journey Events are shown in the Results pane in FIG. 8. However, all events are shown since no particular event category has been selected in the Event drop down box of FIG. 8.

The results shown in the results pane of FIG. 8 show a number of different events associated with a particular customer profile. As previously described, the events may comprise one or more of Check-in, Departure Status—Flown, Update Booking, Cancel Booking, New Booking and so on. Further details of the event may be obtained by selecting the underlined text under the details column shown in FIG. 8.

In the specific example shown in FIG. 8, no recommendations or acknowledgments are associated with a particular event. However, other examples of how recommendations and acknowledgements may be associated with particular events have been previously described.

Various method steps which may be performed by an embodiment of the invention will now be described with reference to FIG. 9 of the drawings. In general, messages may be sent to or/and received by different components of the system using XML messages or other structured message types. This may allow for the exchange information between components of the system.

The process starts at step 901. At step 903, a customer service executive may make a request for a profile, for example using a GUI as shown in FIG. 8 which may be running on a server, laptop or other computer.

At step 905, a particular customer or user profiled may be retrieved from the storage means on the basis of matching Frequent Flyer number, if the processor determines that the customer has a Frequent Flyer number stored in a database.

If the processor determine that the customer does not have a Frequent Flyer number stored in the database, then a profile is retrieved from the storage means on the basis of name plus any or more of the following personal details comprising credit card details, postal address, business address, mobile phone number and email address. Thus, a search key may be used to retrieve one or more profiles from the data base. The key may comprise information such as name and optionally one or more further details outlined above.

If a single profile entry matches the key, then that single profile is returned to the mid tier processing. If a number of records match the search key, then a message is sent to an airline's agent (travel agent or check-in agent) or directly to the customer requesting the customer to provide more information in order to match them uniquely to a single profile.

Accordingly, one or more of customer name plus any of the fields mentioned above may be used to search for a customer. Usually, only when multiple matches are retrieved (for example same name and same address) embodiments of the invention request that more details to make deterministically and usually uniquely match the customer to a stored customer profile. However, in some specific examples, only the previously described details are used in the search, and embodiments of the invention do not search for Age or any other details not previously described.

In either case, at step 907, a get profile request is made to retrieve the profile which is uniquely associated with the user from a database.

At step 909, a value is calculated or determined 909. This may be performed by retrieving one or more rules at step 911, as previously described. At step 913, one or more recommendations are generated as previously described based on the determined value and based on one or more recommendation rules retrieved from a storage means, at step 915.

At step 917, one or more of the profile, value and recommendations may be displayed, for example using a GUI as shown in FIGS. 4 to 6. At step 919, if the recommendation is accepted or rejected, then an acknowledgement is stored 921 in the customer profile database.

At step 923, the activity is displayed along with the recorded recommendation. The agent will usually then take any action implied by the recommendation if it was accepted. Finally, at step 925, the process ends.

From the foregoing, it will be appreciated that the mobile communication or client device may include a computing device, such as a desktop computer, a laptop computer, a tablet computer, a personal digital assistant, a mobile telephone, a smartphone, an internet enabled television, an internet enabled television receiver, an internet enabled games console or portable games device.

The server may comprise a computer processor running one or more server processes for communicating with client devices. The server processes comprise computer readable program instructions for carrying out the operations of the present invention. The computer readable program instructions may be or source code or object code written in or in any combination of suitable programming languages including procedural programming languages such as C, object orientated programming languages such as C#, C++, Java, scripting languages, assembly languages, machine code instructions, instruction-set-architecture (ISA) instructions, and state-setting data.

The wired or wireless communication s networks described above may be public, private, wired or wireless network. The communications network may include one or more of a local area network (LAN), a wide area network (WAN), the Internet, a mobile telephony communication system, or a satellite communication system. The communications network may comprise any suitable infrastructure, including copper cables, optical cables or fibres, routers, firewalls, switches, gateway computers and edge servers.

The system described above may comprise a Graphical User Interface. Embodiments of the invention may include an on-screen graphical user interface. The user interface may be provided, for example, in the form of a widget embedded in a web site, as an application for a device, or on a dedicated landing web page. Computer readable program instructions for implementing the graphical user interface may be downloaded to the client device from a computer readable storage medium via a network, for example, the Internet, a local area network (LAN), a wide area network (WAN) and/or a wireless network. The instructions may be stored in a computer readable storage medium within the client device.

As will be appreciated by one of skill in the art, the invention described herein may be embodied in whole or in part as a method, a data processing system, or a computer program product including computer readable instructions. Accordingly, the invention may take the form of an entirely hardware embodiment or an embodiment combining software, hardware and any other suitable approach or apparatus.

The computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

Exemplary embodiments of the invention may be implemented as circuit board which may include a CPU, a bus, RAM, flash memory, one or more ports for operation of connected I/O apparatus such as printers, display, keypads, sensors and cameras, ROM, a communications sub-system such as a modem, and communications media.

The flowchart of FIGS. 7 and 9 illustrate the operation of an example implementation of systems, methods, and computer program products according to various embodiments of the present invention. Each block in the flowchart or block diagrams may represent a module comprising one or more executable computer instructions, or a portion of an instruction, for implementing the logical function specified in the block. The order of blocks in the diagram is only intended to be illustrative of an example. In alternative implementations, the logical functions illustrated in particular blocks may occur out of the order noted in the figures. For example, two blocks shown as adjacent one another may be carried out simultaneously or, depending on the functionality, in the reverse order. Each block in the flowchart may be implemented in software, hardware or a combination of software and hardware.

Furthermore, from the foregoing it will be appreciated that embodiments of the invention may also be used by airport infrastructure operators who may wish to use a profiling system.

For example, if a user registers with an airport infrastructure provider to use a free wireless internet service by providing an email address and password, provided, of course, customer privacy is respected, airport operators may target offers or services to particular users.

Based on a reason provided by the user for being at the airport such as picking-up, travelling, dropping off, airport infrastructure provides may transmit, usually via wireless communications protocols which will be known to the skilled person, particular data to the customer. A system embodying the invention may also be used to send (usually via a wireless communication protocol) information or discounts to use retail establishments in the airport. For example if the user's propose at the airport is to pick up, then details of the arrival process, or an alert when plane has landed, baggage in hall etc may be transmitted to a user's portable communication device.

Further, merchandising processes may use embodiments of the invention to push offers directly to the customer based on the information known about the customer—attributes of the profile or activity.

The following numbered clauses provide further detail of the invention:
1. A user profiling system comprising:
   communication means for receiving event trigger data in response to a user interacting with an environment;
   processing means configured to:
      uniquely determine user identifier data associated with the event trigger data; and
      associate the event trigger data with a user profile associated with the unique user identifier.
2. A user profiling system according to clause 1 further comprising mapping a plurality of different booking history RBD's each to a different numerical value and further comprising summing each of the values associated with each to produce a weighted flights taken value associated with a customer.
3. A graphical user interface comprising the system of any preceding clause.

1. A user profiling system comprising:
receiver for receiving event trigger data in response to a user interacting with an environment;
a processor configured to:
uniquely determine user identifier data associated with the event trigger data;
associate the event trigger data with a user profile associated with the unique user identifier.

2. A user profiling system according to claim 1, wherein the user is an airline passenger and wherein the system preferably further comprises determining a user profile value based on a user importance code, a user frequency value, and a user history.

3. A user profiling system according to claim 2, wherein the importance code comprises a tiered importance code and wherein a different numerical value is associated with each importance code tier.

4. A user profiling system according to claim 2, wherein the user frequency value comprises a tiered frequency value and wherein a different numerical value is associated with each frequency value tier.

5. A user profiling system according to claim 2, wherein the history comprises a plurality of different reservation booking designators, RBD's, each designator associated with a segment of a journey.

6. A user profiling system according to claim 1 further comprising determining a user profile value based on an equal weighting of a value associated with an importance code and a value associated with a frequent flyer tier level or a value associated with a booking history for a segment of a journey.

7. A user profiling system according to claim 1 further comprising determining whether a frequent flyer attribute is associated with the user profile.

8. A user profiling system according to claim 1 further comprising determining whether a frequent flyer attribute is associated with the user interacting with the environment and preferably searching a customer profile database for a profile comprising a matching frequent flyer attribute and in particular wherein if it is determined that no frequent flyer attribute is associated with the user interacting with the environment, searching a customer profile database based on personal information comprising any one or more of name and credit card details, postal address, business address, mobile telephone number and email address.

9. A user profiling system according to claim 1 further comprising determining whether a frequent flyer attribute is associated with the user profile and wherein if no frequent flyer attribute is associated with the user profile then determining the number of different flight types associated with the customer profile and determining the a customer value for the user based on the sum of weighted values associated with each flight type.

10. A user profiling system according to claim 1 further comprising associating a plurality of different numerical values with a plurality of different RBDs associated with the user booking history.

11. A user profiling system according to claim 1 further comprising determining a customer value on a numerical scale such as 1 to 100 based on the profile attribute and frequent flyer attribute or booking history attribute and preferably storing the determined value in a customer profile database associated with the user.

12. A user profiling system according to claim 1 further comprising determining a whether a profile comprises a profiling link entity linking the profile to a different user profile and preferably wherein the processor determines whether the profile link entity is a link to a nearest neighbour profile and further preferably adjusting the customer value based on the customer value associated with the linked customer profile.

13. A user profiling system according to claim 1 further comprising detecting the occurrence of one or more events and preferably wherein the events comprise one or more of an airport check-in event, a departure status—flown event, an update booking event, a cancel booking event, or a new booking event.

14. A user profiling system according to claim 1 further comprising detecting an event in response to a user scanning a boarding pass, passport or travel document with a scanning means, in particular optical scanning means.

15. A user profiling system according to claim 1 further comprising displaying on a display means a recommendation selected from a plurality of recommendations, wherein the recommendation is selected based on determined value, event and preferably whether one or more recommendations have previously been accepted by the user and preferably wherein the processor is configured to dynamically generate one or more recommendations at a mid-tier processing level based on received events.

16. A user profiling system according to claim 1 further comprising storage means for storing a relational customer profile database and wherein the processor is configured to provide a web-based service.

17. A user profiling system according to claim 1 further comprising receiving means arranged to receive data associated one or more future bookings and preferably to store the received data in a customer profile database stored in a storage means.

18. A user profiling system according to claim 17 further comprising updating the customer value based on the received data associated with one or more future bookings.

19. A computer-implemented user profiling method comprising;
a. receiving event trigger data, with a receiver, in response to a user interacting with an environment; and
with a processor:
uniquely determining user identifier data associated with the event trigger data; and
associating the event trigger data with a user profile associated with the unique user identifier.

20. A computer readable medium which when executed undertakes the method of claim 19.
